(19) United States
(12) Patent Application Publication
(10) Pub. No.: US 2015/0169589 A1
(43) Pub. Date: Jun. 18, 2015

(54) Adjusting Result Rankings For Broad Queries

(71) Applicant: Google Inc., Mountain View, CA (US)

(72) Inventor: Fabio Lopiano, London (GB)

(21) Appl. No.: 14/632,380

(22) Filed: Feb. 26, 2015

Related U.S. Application Data
(63) Continuation of application No. 12/432,586, filed on Apr. 29, 2009, now abandoned.

(51) Int. Cl. G06F 17/30

(52) U.S. Cl. CPC G06F 17/3053; G06F 17/30958

(57) ABSTRACT

Systems, methods, and computer program products are provided for adjusting result rankings for broad queries. In some implementations, a method is provided that includes building a query graph based on submitted queries, each query having one or more query terms, where the query graph contains queries in parent-child relationships. The method further includes for each query in the query graph, determining a respective mass of the query by calculating a total number of submissions of the query and of queries which descend from the query; determining a respective match score of the query based on a correlation between the query and a portion of an electronic document; and computing a respective weight of the query. The method further includes adjusting a ranking of the electronic document as a search result responsive to a current query based on the weight of a matching query in the query graph.

### CROSS REFERENCE TO RELATED APPLICATIONS

This application is a continuation of and claims priority to U.S. patent application Ser. No. 12/432,586, filed on Apr. 29, 2009, the entire contents of which are hereby incorporated by reference.

### BACKGROUND

A Web search engine is a tool designed to search for information on the World Wide Web and retrieve search results that are responsive to user queries. The search results are usually presented in a list and may consist of web pages, images, information and other types of files. Some search engines also mine data available in blogs, databases, or open directories. Web search engines work by storing information about many web pages. These pages are typically retrieved by a Web crawler which follows hyperlinks it encounters on web pages it visits. The contents of each page are then analyzed to determine how it should be indexed (for example, words are extracted from the titles, headings, or special fields called meta tags). Data about web pages are commonly stored in an index database for use in later queries.

### SUMMARY

In general, one aspect of the subject matter described in this specification can be embodied in a method that includes building a query graph based on submitted queries, each query having one or more query terms, where the query graph contains queries in parent-child relationships, in which a child query represents a refinement of a parent query; for each query in the query graph: determining a respective mass of the query by calculating a total number of submissions of the query and of queries which descend from the query; determining a respective match score of the query based on a correlation between the query and a portion of an electronic document; and computing a respective weight of the query in reference to the electronic document based on the mass and the match score of the query; and adjusting a ranking of the electronic document as a search result responsive to a current query based on the weight of a matching query in the query graph, in which adjusting the ranking is performed by one or more processors. Other embodiments of this aspect include corresponding systems, apparatus, and computer program products.

These and other embodiments can optionally include one or more of the following features. The method can further include identifying a two or more queries in the query graph that contain identical query terms, each of the two or more queries being a child query of a distinct parent query; representing the two or more queries as a single query; and substituting the child query of each distinct parent query with the single query.

Determining the match score can optionally include applying a formula

Sm(Q,D)=(Ct/Lq+Ct/Ld)/2

where Sm(Q, D) is the match score that measures the correlation between the query Q and the portion of the electronic document D, Ct is a number of terms that appear in both Q and D, Lq is a length of Q measured by a total number of terms in Q, and Ld is a length of the portion of the electronic document D.

Computing the weight W(Q, D) of the query Q in the query graph in reference to the document D can optionally include multiplying the match score Sm(Q, D) of the query Q by the mass of the query Q.

Computing the weight of the query in the query graph in reference to the document can optionally include multiplying a query count of the query by the match score of the query to produce the weight, the query count comprising a number of times that the query has been submitted; and for each descendent query of the query: multiplying a query count of the descendent query and a match score of the descendent query to produce a descendent query weight; and adding the descendent query weight to the weight.

The portion of the electronic document can be a title of the electronic document or metadata of the electronic document.

Adjusting the ranking of the electronic document can include filtering the query graph by excluding from the query graph queries whose weights do not exceed a threshold; storing an association of the electronic document and the filtered query graph on a storage device; and increasing or decreasing the ranking of the electronic document according to the weight of the matching query in the filtered query graph.

Filtering the query graph can optionally include calculating a score S(Q2, D) for each query Q2 in the query graph in reference to the document D using a formula

S(Q2,D)=W(Q2,D)/M(Q2)−k/N(Q2)

where W(Q2, D) is a weight of the query Q2 in reference to the document D; M(Q2) is a mass of the query Q2; k is the threshold; and N(Q2) is a number of child queries of the query Q2; and excluding from the query graph queries whose scores are less than or equal to 0.

Particular implementations of the subject matter described in this specification can be utilized to realize one or more of the following advantages. The scope of queries that are processed by a query optimizer is increased. Users receive relevant search results in response to broad queries. The scope of documents that are provided as search results is increased. Relevant but short-lived documents are not excluded from search results. A document can be made relevant as a search result even when there is little or no historical information pertaining to it. A document that is otherwise relevant but has few inlinks and outlinks and a short click history can receive a boost in ranking. A document that is not Web-based can be provided as a search result. Documents that are not inter-connected can be included in search results.

The details of one or more implementations of the invention are set forth in the accompanying drawings and the description below. Other features, aspects, and advantages of the invention will become apparent from the description, the drawings, and the claims.

### DESCRIPTION OF DRAWINGS

FIGS. 1A and 1B illustrate example techniques for boosting a ranking of a document in response to a query.

FIGS. 2A-2C are flowcharts illustrating example techniques for using a query graph associated with a document to boost a search rank of the document.

FIGS. 3A-3C illustrate example query graphs for boosting search rankings of a document.

FIG. 4 is a block diagram illustrating example techniques for adjusting a search rank of a document.

FIG. 5 is a flowchart illustrating example query mapping techniques.

FIG. 6 illustrates example techniques for applying query mapping techniques to a current query.

FIG. 7 is a block diagram of a system architecture for implementing the features and operations described in reference to FIGS. 1-6.

Like reference symbols in the various drawings indicate like elements or like steps.

### DETAILED DESCRIPTION

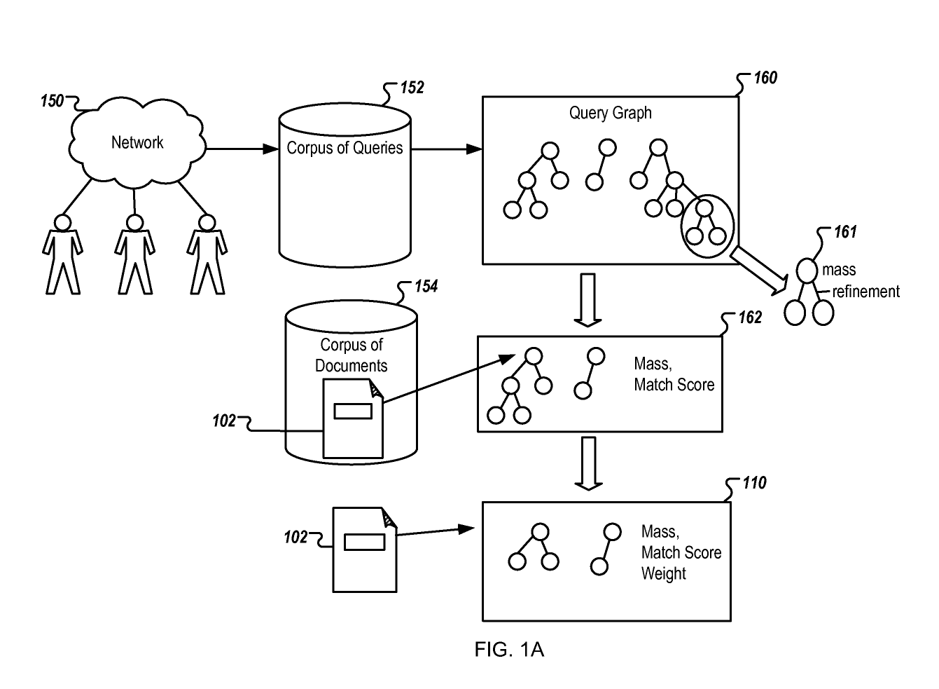

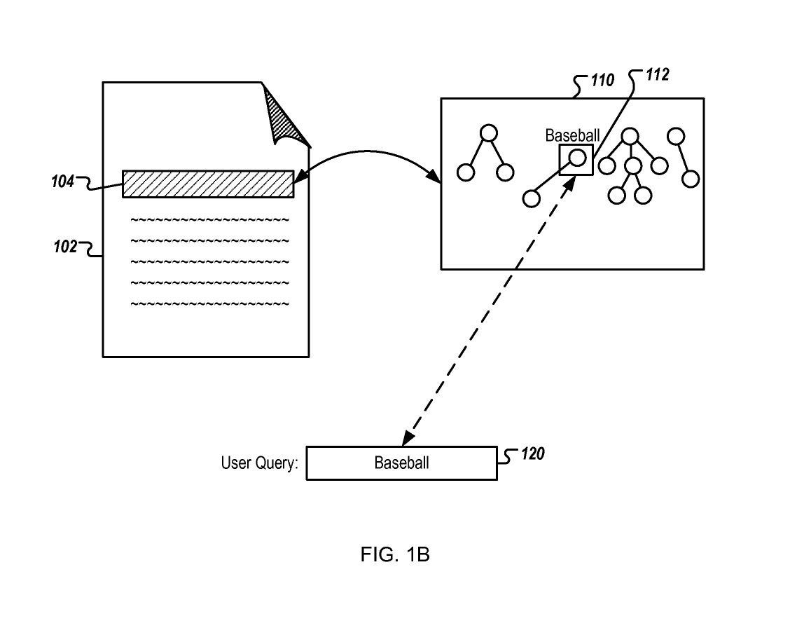

FIGS. 1A and 1B illustrate example techniques for boosting a ranking of a document 102 in response to a query 120. For convenience, the example techniques will be described with respect to a system that performs the techniques. In this specification, the terms “electronic document” and “document” are used interchangeably. A query is information that a user submits to a search engine through network 150 in order to retrieve documents. A query includes one or more terms which are components of the query. By way of illustration, a term can be a part of a word (e.g., “ism”), a word (e.g., “tv”), or a compound that includes more than one word (e.g., “bay area”). Queries can be regarded in parent-child relationships with each other based on query refinements. Query refinements can be determined by query terms. For example, a query “baseball games” is a refinement of the query “baseball” because the query “baseball games” has one more term “games” than the query “baseball.” Therefore, the query “baseball” is a parent of the query “baseball games” and the query “baseball games” is a child of the query “baseball.” In some implementations, query refinements can further be determined by temporal relationships between queries. A query is not designated as a refinement of a prior query, even if the query contains more terms than the prior query, if too much time has elapsed or if there have been too many intervening queries. Therefore, for example, the query “baseball games” is not treated as a refinement of the query “baseball” or counted as a child query of “baseball” in some instances.

The system collects and stores user submitted queries and their refinements. In some implementations, collected queries and refinements are represented as one or more query graphs (e.g., 160, 162, or 110). Each of the query graphs 160, 162, and 110 is a directed acyclic graph (“DAG”) where nodes in the graph represent queries, and edges between nodes represent the parent-child hierarchical relationships of the queries. The DAG can include, but is not limited to, trees or forests. Other data structures are possible, however.

FIG. 1A illustrates example techniques for building a filtered query graph 110 for the document 102. The filtered query graph 110 is used to boost a ranking for a document 102 as a search result for the query 120. The ranking measures the relatedness between the document 102 and the user query 120.

Queries submitted by one or more populations of users are collected over a time period in a corpus of queries 152. The system uses the corpus of queries 152 to build the system query graph 160. In the system query graph 160, queries in the corpus 152 are organized based on the parent-child relationships. By way of illustration, for a parent query (“Q”), child queries (“Q1”, . . . “Qn”) are refinements of the parent query Q. A query Q1 is a refinement of a query Q if Q1 contains all query terms in the query Q and at least one query term that is not in the query Q. For example, the query “baseball games” is one of the refinement queries of the query “baseball.” The query term “games” is the refinement. The direction of an edge in the system query graph 160 thus points from “baseball” to “games,” indicating that “baseball games” is a refinement query of the query “baseball.”

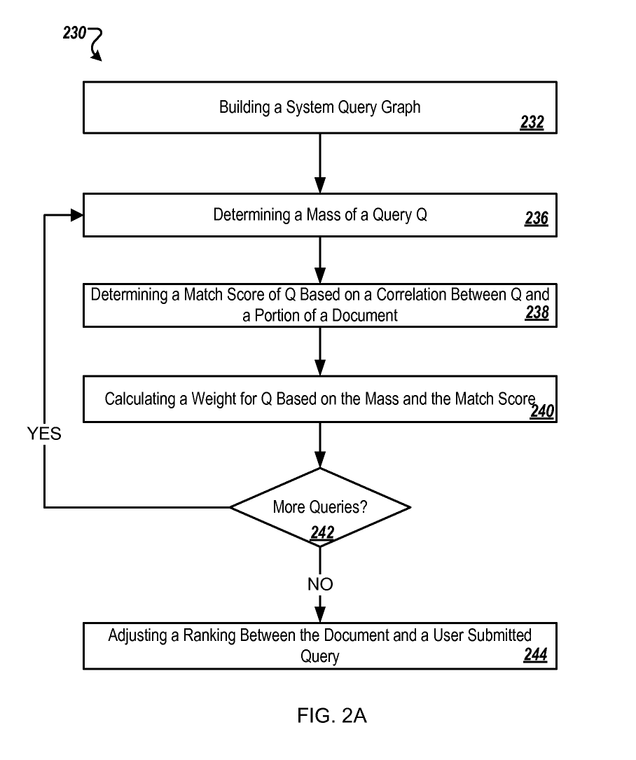

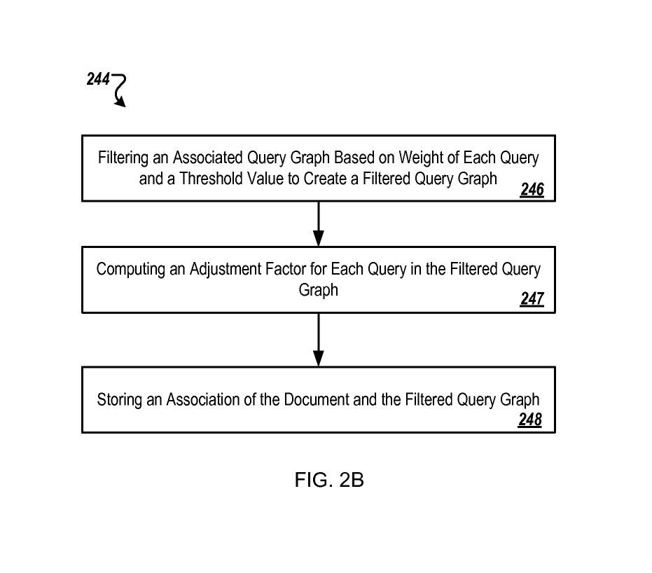

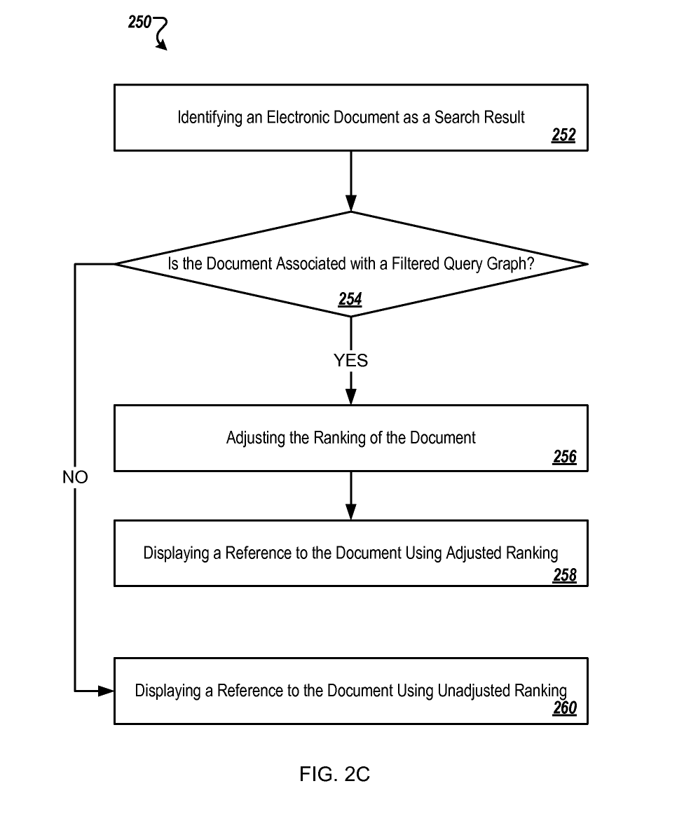

For each query in the system query graph 160 (e.g., query 161), a mass is calculated. The mass of the query measures how popular the query is. For example, a mass of a query can be the number of times the query and the query's children have been submitted by one or more populations of users. Other ways of determining mass is possible. More details on calculating the mass of the query will be described below with respect to FIG. 2A.

From the system query graph 160, the system generates a query graph 162. The query graph 162 is for a specific document 102. The query graph 162 contains queries from the system query graph 160 which have query terms that are present in at least a portion 104 of the document 102. The electronic document 102 can be a document such as a Web page or other content in a corpus of documents 154. The corpus 154 of documents is a space of documents that a search engine can search, such as the World Wide Web or a database, for instance.

The system determines how related a query in the query graph 162 is to the document 102 by calculating a match score. In some implementations, the match score is calculated for each query in the query graph 162 in relation to the document 102 based on the number of terms that are present in both the query and the title of document 102. Thus, if the query is “baseball games,” and the document 102 has title “Baseball Game Tickets,” the query has a high match score in relation to the document 102. If, on the other hand, the document 102 has a title “LCD monitors,” the match score is zero, because no term in “baseball games” matches “LCD monitors.” The query graph 162 contains queries in the system query graph 160 whose match scores are non-zero.

The system filters the query graph 162 to obtain the filtered query graph 110 for document 102. To filter the query graph 162, the system calculates a weight for each query in the query graph 162 by combining the match score of the query with the mass of the query 120. The system uses the weight to select popular queries that are closely related to document 102. The selected popular queries that are closely related to document 102 are components of the filtered query graph 110. The association between query graph 110 and document 102 is used for boosting the rank of document 102 as a search result for a query.

FIG. 1B illustrates example techniques for boosting search ranking of the document 102 at query time. As an example, the document 102 is associated with the filtered query graph 110. The filtered query graph 110 contains queries that have been selected by weight. When a user submits the query 120, a search engine generates a search rank for document 102 responsive to the query. The search rank is based on, for example, a result score of the document 102 that has been given to the document 102 by the search engine. In various implementations, the techniques described in this specification are applied to various search ranks and result scores of various search engines.

The system locates a matching query 112 in the filtered query graph 110 that matches the user issued query 120. The matching query 112 in the filtered query graph has an adjustment factor. The adjustment factor is used to boost the search rank of the document 102. In various implementations, the adjustment factor can be based on the weight of the matching query or other values. For example, if the user enters a query 120 “baseball,” the weight calculated for matching query “baseball” 112 in query graph 110 is used to adjust the result score associated with document 102 returned from the search engine. According to the weight of the matching query 112 “baseball” in the filtered query graph 110, the matching query 112 “baseball” is both popular (based on the mass) and closely related to document 102 (based on the match score). The search rank of document 102 thus receives a boost.

FIGS. 2A-2C are flowcharts illustrating example techniques for using a query graph associated with a document to boost a search rank of the document. In step 232, a system query graph 160 is built based on queries submitted by one or more populations of users over a period of time. In some implementations, the query terms in the submitted queries are normalized by removing punctuation and lower-case the letters in the term (e.g., “Sam's Place” to “sams place”), for example. Normalizing a query term can also include changing the term to singular form (e.g., from “bats” to “bat”). Other ways of normalizing queries are possible. In some implementations, the system query graph 160 is a directional acyclic graph containing nodes and edges where nodes represent queries and edges represent relationships between two queries. Queries in the system query graph 160 relate to each other in a parent-child relationship.

The system performs iterations on at least some queries in the system query graph 160. In various implementations, each iteration traverses a tree of queries in a breadth-first mode, a depth-first mode, or using other tree-traversing algorithms. The iterations can traverse all queries in the system query graph 160. For convenience, the steps 236-240 within each iteration will be described with respect to a query Q being iterated upon.

In step 236, the system determines a mass of the query Q. In some implementations, the mass of the query Q is calculated based on a number of times the query Q has been submitted by the population. For the query Q, the mass of the query M(Q) is a total number of submissions of the query Q and all child queries of query Q. For example, the system query graph 160 includes two queries “baseball” and “baseball bats” and the query “baseball” does not have another child query. The parent query Q “baseball” has a count of 200 submissions and the child query “baseball bats” as a count of 100 submissions. The mass for the two queries are 300 (200+100=300) and 100, respectively.

In some implementations, the system uses a number of generations of query refinements as a limiting factor in calculating the mass of the query Q. For example, the system can use the number of submissions of two generations of queries (i.e., Q and Q's direct child queries) to calculate the mass of the query Q. A direct child query Q′ of the query Q is a one-level refinement of the query Q. Q′ is a one-level refinement of Q if Q′ contains one more term than the query Q. By way of illustration, the mass for an example query Q “baseball” is a sum of number of times the query “baseball” is submitted, plus a number of times that each of a direct child query of “baseball” is submitted. The direct child queries of query “baseball” can be “baseball bat,” “baseball cap,” “baseball game,” etc.

In some other implementations, the system does not use the number of generations as a limiting factor in calculating the mass of the query Q−all linear descendent queries of the query Q (e.g., Q's children, Q's children's children, and so on) are counted to calculate a mass of the query Q. Therefore, the mass M(“baseball”) for the query “baseball” can include counts of numbers of submissions of any query that refines the query “baseball,” e.g., “baseball games,” “baseball bats,” “baseball bats sales,” “baseball bats sales new york,” etc.

In some implementations, the mass M(Q) of the query Q is calculated by recursively traversing the child queries of Q. An example formula for calculating M(Q) is

$$M ( Q ) = Count ( Q ) + {\sum }_{i = 1}^{n} M ( {Q}_{i} )$$

where M(Q) is the mass of the query Q, Count(Q) is the number of submissions of the query Q; n is the number of child queries of the query Q; and Qi is the i-th child query of Q, if Q has any child queries. If Q has no child query, M(Q) is degenerated into Count(Q). The following is example pseudo-code for calculating M(Q):

M(Q)=Count(Q)+Sum(M(Q′) for each Q′ child query of Q) (1)

In some implementations, various functions F(Q) can be used in place of Count(Q) to calculate the mass M(Q). For example, F(Q) can be a function that measures a number of clicks on results returned for query Q. F(Q) can be a combination of the number of clicks and the Count(Q). F(Q) can also incorporate other signals (e.g., the language of the query, the diversity of geographic locations from which the query was submitted, the time that a particular query has existed in the system, etc.)

In step 238, a match score is calculated for the query Q, based on a correlation between query terms in the query Q and the portion 104 of the electronic document 102. In general, the electronic document 102 can be any document in the corpus 152 of documents. Specifically, the electronic document 102 can be document that has short life span and no in-links (e.g., hyperlinks outside the document 102 that point to document 102) or out-links (e.g., hyperlinks within the document 102 that point to other documents). In various implementations, the portion 104 of the electronic document 102 is various parts of the document 102, including the complete document 102. In some implementations, the portion 104 of the document 102 used in calculating the match score is the title of the document 102 or metadata of the document 102. The title of the document 102 is located in the <title> tag if the document 102 is in HTML format, for example. The metadata are provided by a supplier (e.g., an author) of the document 102.

The system calculates the match score, which measures a relatedness between the query Q and the document 102 by measuring the query Q's hits on the portion 104 of the document 102. In some implementations, a hit is a term that is present in both the query Q and the portion 104 of the document 102. In some implementations, the match score has a value between 0.0 and 1.0, inclusive, for instance. A value of 1.0 can mean that the query Q and the portion 104 of the document 102 are equivalent. A value of 0.0 can mean that the query Q and the portion 104 of the document 102 share no common terms, for instance. A value between 0.0 and 1.0 can mean that a partial match exists between the query Q and the portion 104 of the document 102.

In some implementations, the match score Sm(Q, D) between the query Q and the document 102 D is computed using the following formula:

Sm(Q,D)=(Ct/Lq+Ct/Ld)/2 (2)

where Sm(Q, D) is the match score based on a relatedness between the query Q and the electronic document 102 D; Ct is a number of terms that appear in both the query Q and the portion 104 document 102 D; Lq is a length of the query Q, measured by a number of terms in Q; and Ld is a length of the portion 104 of D, measured by a number of terms in D. For example, the title 104 of the document 102 D is used in calculating a match score. The match score between the query “baseball bat” and the document 102 titled “Baseball Bat on Sale” is 0.75((2/2+2/4)/2=0.75). The match score between the query “baseball bat” and a document titled “Baseball Games” is 0.5((1/2+1/2)/2=0.5). The match score between a query “baseball bat” and a document titled “Digital Camera on Sale” is 0. In some implementations, if the query Q in the system query graph 160 has a match score that is greater than 0, the query Q is associated with the document 102 and is included in the query graph 162, otherwise, the query Q is excluded from the query graph 162.

In step 240, the system calculates a weight for the query Q, based on the mass and the match score of the query Q. The weight of the query Q is calculated in reference to the document 102. The weight for the query Q is associated with the query Q in the query graph 162. In some implementations, a weight W(Q, D) of the query Q in reference to document D is computed by multiplying the match score Sm(Q, D) of the query Q with the mass M(Q) of the query Q. In some implementations, a weight W(Q, D) of the query Q is calculated by multiplying the match score Sm(Q, D) with a query count of the query Q (e.g., Count(Q)).

In some implementations, the weight W(Q, D) of the query Q in reference to document D is computed recursively on Q and Q's child queries. The query count Count(Q) of the query Q and the match score Sm(Q, D) of query Q can be multiplied to produce a local weight of the query Q. All child queries of query Q can be recursively traversed. For each child query Q′ of query Q, the mass M(Q′) of the child query Q′ and the match score Sm(Q′, D) of child query Q′ are multiplied to produce a child weight W(Q′, D). The child weight W(Q′, D) is added to the local weight of the query Q. Example pseudo-code for calculating W(Q, D) is:

W(Q,D)=Count(Q)*Sm(Q,D)+Sum(W(Q′,D) for each Q′ child query of Q) (3)

In case where query Q has no child queries, the weight W(Q, D) degenerates into Count(Q)*Sm(Q, D). In these implementations, the weight W(Q, D) of the query Q in reference to document D includes a sum of local weights of each of the descendent queries of the query Q.

In step 242, a termination condition for the iterations is examined. The termination condition is a condition which, when satisfied, stops an iteration from repeating. For example, iteration repeated for each query in the system query graph 160 stops when all queries in the system query graph 160 have been traversed. If there are more queries in the system query graph 160 to be traversed, the system continues the iteration.

In step 244, the system adjusts the ranking of the electronic document 102 in response to the user submitted query 120. The ranking reflects how closely the document 102 relates to the specific user query 120. The ranking can be used to determine a rank position of the document 102 among multiple documents that are search results for the query 120. In some implementations, adjusting the ranking can include generating a filtered query graph 110 for document 102 from query graph 162, identifying a query 112 in the filtered query graph 110 that matches the user query 120 at query time, and adjusting the ranking based on an adjustment factor of the matching query 112. For example, if a user enters a broad query 120 “baseball,” the system first identifies documents that are associated with the filtered query graph 110. The system then identifies the documents whose filtered query graphs 110 contain a matching query “baseball.” Rankings (e.g., result scores) of these documents receive a boost based on the adjustment factor that is associated with the matching query “baseball.” More details on adjusting the ranking of the electronic document 102, including how documents are related to queries and how adjustment factors are calculated, are described below with respect to FIG. 2B.

FIG. 2B is a flow chart illustrating example technique 244 for adjusting the ranking of the electronic document 102 as a search result for the user query 120. In step 246, the system filters the query graph 162 by comparing the weight and mass of each query and selecting queries in the query graph 162 whose weight reaches a threshold fraction of their mass. The system creates a filtered query graph 110 based on the selection. In some implementations, if the ratio between the weight and the mass of a query exceeds the value of the threshold fraction, the query is selected from the query graph 162 and included in the filtered query graph 110. Otherwise, the query is discarded or otherwise excluded from the filtered query graph 110. For example, when the threshold fraction value is set to 0.35 and the mass of a query is 10, the query is selected and included in the filtered query graph 110 if its weight is 3.5 or above.

In some implementations, filtering the query graph 162 includes calculating a score S(Q, D) for each query Q in query graph 162 in reference to document 102 D using the following formula:

S(Q,D)=W(Q,D)/M(Q)−k/N(Q) (4)

where W(Q, D) is the weight of the query Q in reference to document D, M(Q) is the mass of the query Q, k is a threshold value, and N(Q) is the number of child queries of the query Q. The threshold value k is a number between 0.0 and 1.0. Queries whose scores are greater than 0 are selected and included in the filtered query graph 110.

In step 247, the system calculates an adjustment factor of each query in the filtered query graph 110. In some implementations, the adjustment factor of a query is calculated based on the weight of the query and a quality score. The quality score is a value that relates to the trustworthiness of the source of a document. For example, a product-promotion document from a trusted merchant can have a quality score above 1.0; a product-promotion document from an average merchant can have a quality score of 1.0; and a product-promotion document from an unreliable merchant can have a quality score that is below 1.0.

In step 248, the filtered query graph 110 is associated with the document 102. The association of the filtered query graph 110 and the document 102 is stored on a storage device. The filtered query graph 110 and the electronic document 102 can be stored together or separately. The filtered query graph 110 can be updated periodically during the lifetime of the electronic document 102, based on new user submitted queries. The system uses the filtered query graph 110 to boost the search rank of document 102. The details on using filtered query graph 110 associated with the document 102 to boost the search ranking of the document 102 is described below with respect to FIG. 2C.

FIG. 2C is a flow chart illustrating example techniques 250 for using the filtered query graph 110 associated with the document 102 to boost the search ranking of the document 102 at query time. In step 252, the electronic document 102 is identified as a search result for the current user query 120. The search result is associated with a result score which measures how closely the document 102 matches the current user query 120.

In step 254, the system determines whether the document 102 is associated with the filtered query graph 110. If the document 102 is not associated with a filtered query graph 110, the system does not adjust the ranking of the document 102. When the system presents a reference to the document 102 to the user as a search result in step 260, the system can use the unadjusted ranking of the document 102 to determine a display position of the reference.

If the system determines that the document 102 is associated with a filtered query graph 110, the ranking of the document is adjusted in step 256. Adjusting the ranking can include increasing or decreasing the result score of document 102. For example, the result score associated with document 102 is increased or decreased based on an adjustment factor of a matching query 112 in the filtered query graph 110. For example, if the current user query 120 is “baseball,” the adjustment factor associated with a matching query “baseball” in the filtered query graph 110 will be used. In some implementations, the adjustment factor is added to the result score. In some other implementations, the result score is multiplied by the adjustment factor. Other mathematical formulas can also be used to increase or decrease the result score based on the adjustment factor. When the system presents a reference to the document 102 to the user as a search result in step 258, the system can use the adjusted ranking of the document 102 to determine a display position of the reference.

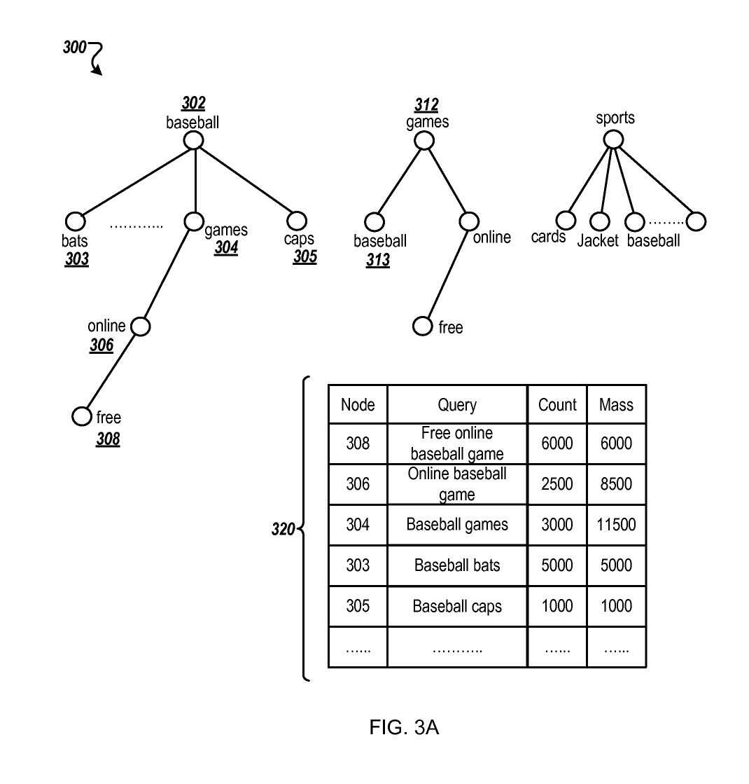

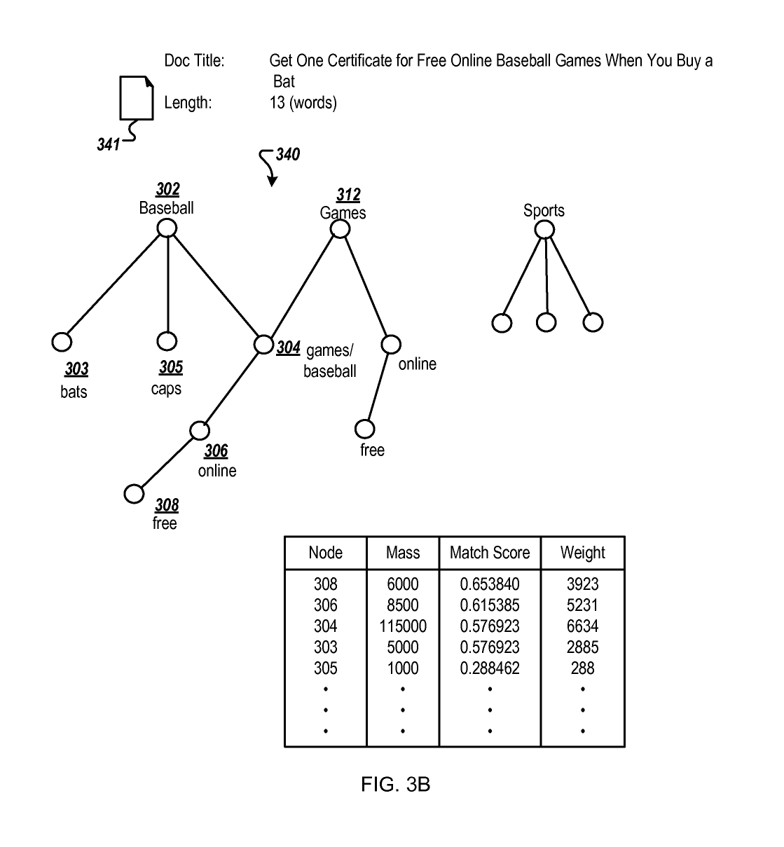

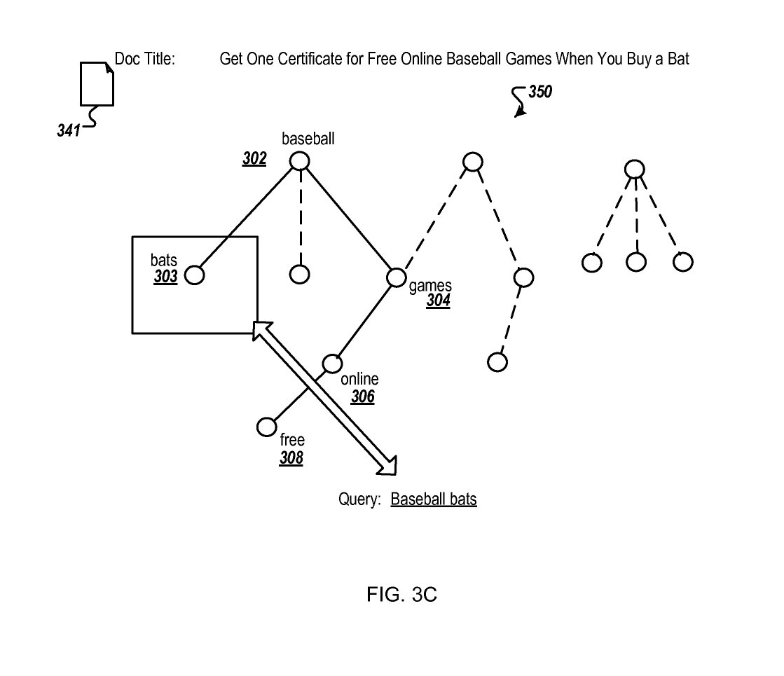

FIGS. 3A-3C illustrate example query graphs 300, 340, and 350 for boosting the ranking of a document as a result for a query. In FIG. 3A, an example system query graph 300 contains multiple trees. The root of each tree is a query that contains a single term, and represents the query containing the term. For example, root node 302 represents query “baseball,” and root node 312 represents query “games,” etc. Each query Q in the system query graph 300 can be associated with a query count Count(Q) that represents the number of times the query Q has been submitted by one or more populations of users.

In some implementations, the order of the query terms in a query determines to which tree the query belongs. For example, a query 313 “games baseball” is in a tree whose root 312 is a query “games,” whereas a query 304 “baseball games” is in a tree whose root 302 is a query “baseball.” In some other implementations, the system ignores the order of the terms in the query when creating the system query graph 300. Therefore, the queries 313 and 304 can represent either “baseball games” or “games baseball.”

The system query graph 300 can be optimized by sharing common sub-trees. Two or more nodes in the system query graph 300 that represent queries that contain the same query terms are identified. The nodes can be in different trees and have distinct parent nodes. The nodes that represent queries that contain the same query terms are merged into a single node. The single node is made a child node of the distinct parent nodes in the query graph as a substitute of the two or more nodes.

For example, in system query graph 300, nodes 304 and 313 can represent queries “baseball games” and “games baseball,” respectively. Node 304 is in a tree whose root is node 302 (“baseball”). Node 313 is in a tree whose root is node 312 (“games”). Nodes 304 and 313 therefore can be merged and represented as a single query. In some implementations where the order of the query terms are irrelevant, node 304 and node 313 can each have the same query count. Therefore, one of nodes 304 and 313 can be discarded, along with the sub-tree to which the node 304 or 313 is a root.

In other implementations in which the order of the query terms is significant in the system query graph 300, the query optimization process creates an optimized system query graph in which the order of query terms is ignored. For example, queries “baseball games” and “games baseball” are originally regarded as two different queries. Query “baseball games” has a query count (e.g., 300), and “games baseball” has another query count (e.g., 50). In these implementations, merging nodes 304 and 313 includes creating a new node, whose query count is a sum of the query counts of node 304 and 313 (e.g., 300+50=350). The new node can represent both query “baseball games” and query “games baseball.” In addition to merging nodes 304 and 313, sub-trees of nodes 304 and 313 can also be merged accordingly.

In some implementations, after the nodes are merged into a single node and their children nodes are merged into a sub-tree in which the single node is a root, the single node is assigned to the former parent nodes as a child node for each parent node. For example, after merging nodes 313 and 304 into node 304, node 304 becomes a child node for both parent nodes 302 and 312.

The system can calculate the mass for each node based on the query count using the pseudo code (1) described above. By way of illustration, node 304 has a query count of 3,000, indicating that there are 3,000 submissions of the queries “baseball games” or “games baseball” in the corpus 152. Node 304 has two descendent nodes 306 and 308. Node 306 has a query count of 2,500, and node 308 has a query count of 6,000. Therefore, the mass of node 308 (“baseball games online free”) is 6,000. The mass of node 306 (“baseball games online”) is 8,500 (6,000+2,500=8,500). The mass of node 304 is 11,500 (8,500+3,000=11,500). The mass of each node can be stored in a data structure on a storage device. The data structure can be a table 320.

In the system query graph 300, the maximum depth of the three trees is four. In various implementations, the system query graph 300 includes queries submitted from a large number of users over a long period of time. Therefore, the number of trees in the system query graph 300 can exceed three, and the depth of the trees can exceed four.

FIG. 3B illustrates an example query graph 340 for document 341. Query graph 340 contains trees that have shared sub-trees. A match score and a weight are calculated for each query in the query graph 340 in reference to document 341. In some implementations, the match score is calculated based on the query terms in a query and the title of the document 341 using formula (2) as described above. Example document 341 has a title “Get One Certificate for Free Online Baseball Games When You Buy a Bat.” The length (Ld) of the title is 13. Query 308 contains terms “baseball games online free.” The length (Lq) of the query is 4. The order of the terms in the query 308 is irrelevant. The terms “free,” “online,” “baseball” and “games” are in both the query 308 and the title of the document 341. Therefore, the number of terms that are in both the title and the query (Ct) is 4. Applying formula (2), the match score between query 308 and document 341 Sm(query 308, document 341) is

(4/4+4/13)/2≈0.653846

The match score and the mass can be used to calculate a weight. In some implementations, the weight of each query in relation to the document 341 is calculated by multiplying the query's match score in relation to the document 341 with the mass of the query. Therefore, for example, the weight of query 308 whose mass is 6,000 is 3,923 (6,000*0.653846≈3,923), and the weight of query 306 is 5,231 (8,500*0.615385≈5321), etc.

In some implementations, the weight for each query is calculated recursively using pseudo code (3). In these implementations, the weight of query 308 is 3,923, and the weight of node 306 is 5,469 (2,500*0.615385+3,923≈5,469). Here, 2,500 is the query count for node 306, and 0.615385 is the match score of query 306 in relation to document 341. The weight if each node can be used to filter the query graph 340. Filtering the query graph 340 can include applying formula (4) to each of the queries in the query graph 340.

In some implementations, the system normalizes the weights for the queries in the query graph 340. Normalizing the weights can include locating a maximum weight of the queries in the query graph 340, and dividing the weight of each query in the query graph 340 by the maximum weight. For example, if the maximum weight in the query graph 340 is 6,634 (e.g., of node 304), the normalized weights for queries 304, 306, and 308 can be 1, 0.59 (3,923/6,634), and 0.79 (5,231/6,634), respectively.

FIG. 3C illustrates an example filtered query graph 350. The filtered query graph 350 contains queries that can be used to match current user queries (e.g., query 120) at query time. In the filtered query graph 350, nodes connected by dotted lines (except node 302 and 304) represent queries that have been excluded for lacking sufficient weights or scores. For example, after applying formula (4), the entire tree under “sports” in the query graph 340 is excluded from the filtered query graph 350. The filtered query graph 350 includes part of the tree under node 312 (which has a root “games”). A child query 304 “baseball games” under query 302 “baseball” is selected.

Each query in the filtered query graph 350 can be associated with an adjustment factor. In some implementations, the adjustment factor can be a number that is calculated from the weight of the query and a quality score. The quality score can measure quality of the document 341 in relation to other documents in a corpus of documents. An example quality score is the Quality Index (QI) of Yahoo! Search. The filtered query graph 350 and the adjustment factor for each query can be associated with document 341 and stored on a storage device.

At query time, a customer can issue a current user query such as “baseball bat.” The query is matched against the filtered query graph 350. If a query 303 matches the current user query, the adjustment factor associated with query 303 and document 341 can be used as an input to a document ranking process, to adjust the rank of document 341.

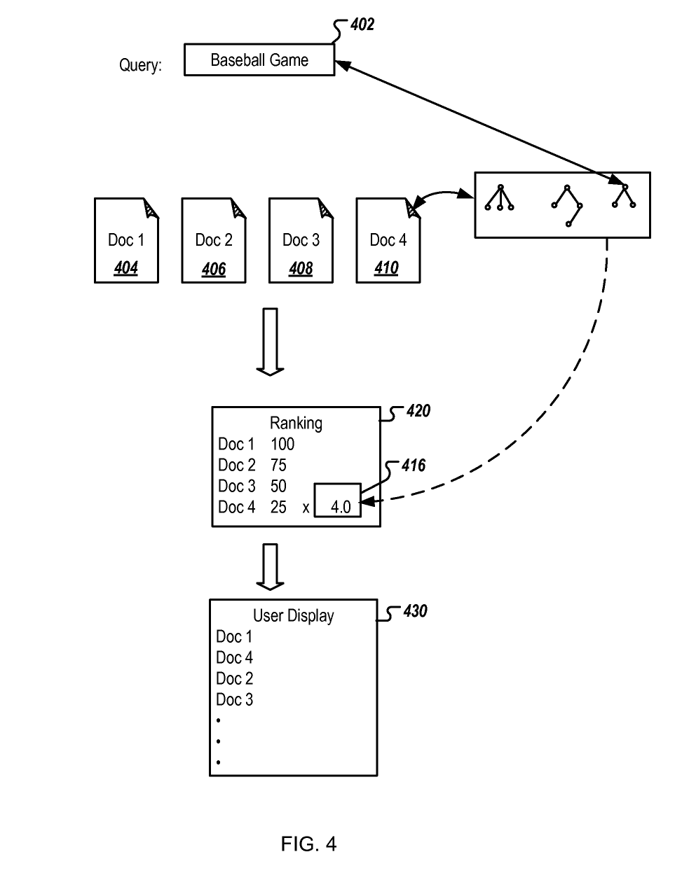

FIG. 4 is a block diagram illustrating example techniques for adjusting a rank of a document 410. In response to a user query 402 which contains the terms “baseball” and “game,” a search engine locates documents 404, 406, 408, and 410. Based on relevancy, the search engine gives each of the documents 404, 406, 408, and 410 a result score. Any search engine can be used. Some example search engines are wikiseek, Yahoo! Search, or Ask.com. The higher the result score, the more relevant to the query the document is. The result score can be calculated by a traditional search engine. For example, document 404, 406, 408, and 410 can have result scores 100, 75, 50, and 20, respectively. Document 410 has the lowest result score and therefore ranks the lowest.

Document 410 can be associated with a filtered query graph 412. In this example, user query 402 matches a node in the filtered query graph 412 which represents a query whose terms are “baseball” and “game.” The matching node in the filtered query graph 412 can have an adjustment factor 416 (e.g., “4.0”) that can be applied to the result score of document 410. Therefore, the adjustment factor 416 of the matched node is used as an input to an example document ranking process 420. By way of illustration, because of the adjustment factor 416, the result score of document 410 is multiplied by the value 4.0 and thus adjusted from “20” to “80.”

The ranked documents are ordered and provided to the user on a display 430, in response to the query 402. By way of illustration, document 410, having an adjusted result score of “80,” ranks the second in the list of documents. Therefore, a reference (e.g. a Uniform Resource Locator or URL) to document 410 can be displayed in the second place, instead of fourth place, on the user display.

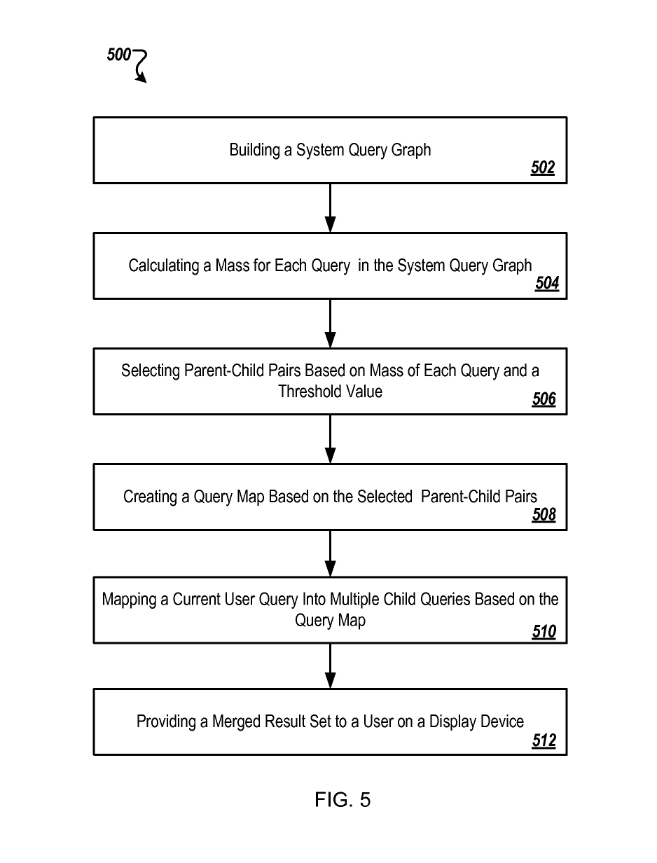

FIG. 5 is a flowchart illustrating example query mapping techniques 500. Query mapping techniques can be applied to map a broad user query (e.g., “baseball”) into multiple detailed queries (e.g., “baseball bat,” “baseball bat sale,” and “baseball cap,” etc.) using a query map. Compared to the broad user query, the detailed queries contain additional information that may be of significance to a search engine's document ranking algorithm, which, in turn, can lead to results that are more relevant. In some implementations, the query map is combined with other rank-adjusting techniques.

In step 502, the system builds a system query graph 160 based on queries submitted by one or more populations of users. Building 502 the system query graph 160 can include applying techniques described above with respect to FIG. 2A.

In step 504, the system calculates a mass for each query Q in the system query graph 160 based on a number of queries submitted. The mass M(Q) of the query Q in the query graph is a total number of submissions of the queries Q and all child queries of query Q.

In step 506, parent-child pairs in the system query graph 160 are selected based on the mass of each query and a threshold value. The selected parent-child pairs can be used to construct the query map. In some implementations, a parent-child pair includes two queries, a parent query Q and a child query Q1. The child query Q1 is a one-level refinement of the parent query Q. If the mass of the child query Q1 exceeds a fraction of the parent query Q, the pair of queries Q and Q1 is selected as a parent-child pair (Q, Q1). The fraction is a threshold value that can be adjusted.

A threshold value can be between 0.0 and 1.0, inclusive. Setting the threshold to 0.0 can allow the system to select the all the query pairs (Q, Q1), (Q, Q2), . . . (Q, Qn), in which Q1-Qn are children of Q. Setting the threshold value to 1.0 allows the system to select query Q and at most one child query of Q as the parent-child pair. The threshold can be adjusted based on various sensitivity requirements. For example, when the threshold value is 0.25, the number of parent-child pairs for a given parent is limited to 3.

In some implementations, parent-child pairs can be selected from the system query graph 160. Example pseudo code for identifying parent-child pairs can be:

for each node Q in a system query graph 160

for each child node Q′ of node Q

if M(Q′)>M(Q)*Vt

then select parent-child pair (Q,Q′) (5)

where M(Q) is the mass of a query Q, Vt is a threshold value.

In step 508, a query map is created based on the identified parent-child pairs. The query map can be a collection of the selected parent-child pairs. Some example parent-child pairs in a query map are (tv, plasma tv), (tv, flatscreen tv), and (tv, lcd tv).

In step 510, the system maps a current user query 120 into multiple child queries using the query map. Upon receiving a current user query 120, the system performs a look-up in the query map. The look-up identifies one or more child queries whose parents match the current user query 120. The system submits the child queries, instead of the current user query, to a search engine. For example, a user submits a broad query “tv.” Three parent-child pairs (tv, plasma tv), (tv, flatscreen tv), and (tv, lcd tv) exist in the stored query map. Therefore, the system maps the broad query “tv” into three sub-queries “plasma tv,” “flatscreen tv,” and “lcd tv.” The three child queries, instead of broad query “tv,” are submitted to a search engine.

The three child queries “plasma tv,” “flatscreen tv,” and “lcd tv” passed to a search engine can each retrieve a search result set. The result set can be a list of documents or references to documents. Each document or reference in the result has a result score, which can determine a ranking of the document or reference in the list.

In step 512, a merged result set is provided on a display device to a user. The merged result set includes the result sets of each sub-query. The documents or references in the merged result set are ranked together according to the result score of each document or reference. The system can display the documents or references in the merged result set on a display device according to the ranking of the documents.

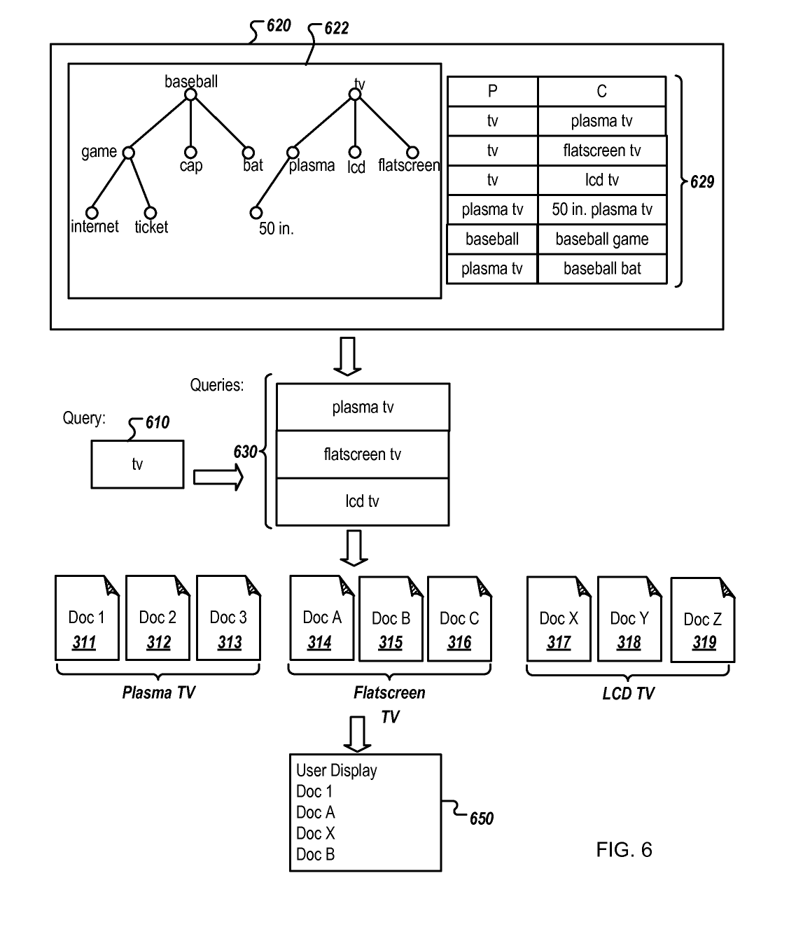

FIG. 6 illustrates example techniques for applying query mapping techniques to a current query 610. A storage device stores a query mapping program 620. The query mapping program 620 includes one or more query graphs 622. The queries in query graph 622 relate to each other in parent-child relationships. Multiple versions of query graphs 622 can be maintained, for example, for different periods of time, different geographical locations, different languages, etc.

Query mapping program 620 also contains one or more query maps 624. A query map 624 contains parent-child pairs of queries. The parent-child pairs of queries can be identified from the query graph 622, based on the mass or weight of the query nodes in query graph 622 and a threshold value. If multiple versions of query graphs 622 (e.g., multiple query graphs for multiple documents) are used, multiple versions of the query map 624 can be maintained, each version of the query map 624 corresponding to a particular version of query graph 622

When a user submits a broad current query 610 (e.g., “tv”) to the system, the system performs a lookup on the current query 610 in the query map 624. If the system locates child queries 630 of the current query 610, the system submits the child queries 630, instead of the current query 610, to a search engine. For example, the broad query “tv” has three child queries “plasma tv,” “flatscreen tv,” and “lcd tv” in the query map 624. Therefore, child queries 630 can contain the three child queries “plasma tv,” “flatscreen tv,” and “lcd tv.”

In some implementations, the system performs more than one round of query lookups in the query map 624. In a first round, the system identifies the child queries 630 of the current query 610. In a next round, the system identifies child queries of each of the child queries 630 identified in the first round. The system repeats the process until a desired level of details is reached. For example, when a user enters the current query 610 “tv,” the system identifies child queries 630 “plasma tv,” “flat-screen tv,” and “lcd tv” in a first round of query map lookup. In a second round, the system identifies query “50-inch plasma tv” based on the parent-child pair (plasma tv, 50-inch plasma tv). The query “50-inch plasma tv” is added to the collection of child queries 630.

In various implementations, the one or more child queries in the children query set 630 are submitted to the search engine to obtain result sets. The result sets each contains a collection of documents (or references to documents) as search results. Each of the documents can be associated with a result score. For example, documents 311, 312, and 313 form a first result set of child query “plasma tv.” Documents 314, 315, and 316 form a second result set of child query “flatscreen tv.” Documents 317, 318, and 319 form a third result set of child query “lcd tv.”

The documents 311, 312, 313, 314, 315, 316, 317, 318, and 319 in the result sets are merged into a merged result set. The references to the documents in the merged result set (e.g., URL links to each of the documents) are displayed on a display device 650. The order of display is determined by the ranking of the documents according to the result scores of the documents. For example, the order can be document 311 from the first result set, followed by document 314 from the second result set, followed by document 317 from the third result set, followed by document 315 from the second result set, and so on. A program can paginate the result set into a first display page, a second display page, etc.

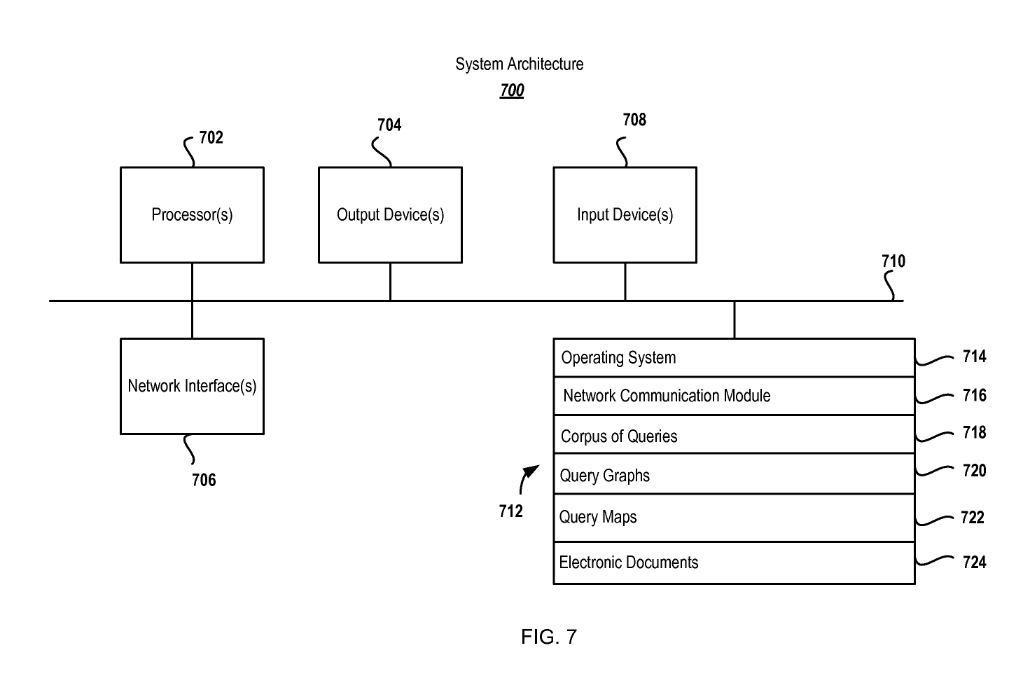

FIG. 7 is a block diagram of a system architecture 700 for implementing the features and operations described in reference to FIGS. 1-6. Other architectures are possible, including architectures with more or fewer components. In some implementations, the architecture 700 includes one or more processors 702 (e.g., dual-core Intel® Xeon® Processors), one or more output devices 704 (e.g., LCD), one or more network interfaces 706, one or more input devices 708 (e.g., mouse, keyboard, touch-sensitive display) and one or more computer-readable mediums 712 (e.g., RAM, ROM, SDRAM, hard disk, optical disk, flash memory, etc.). These components can exchange communications and data over one or more communication channels 170 (e.g., buses), which can utilize various hardware and software for facilitating the transfer of data and control signals between components.

The term “computer-readable medium” refers to any medium that participates in providing instructions to a processor 702 for execution, including without limitation, non-volatile media (e.g., optical or magnetic disks), volatile media (e.g., memory) and transmission media. Transmission media includes, without limitation, coaxial cables, copper wire and fiber optics.

The computer-readable medium 712 further includes an operating system 714 (e.g., Mac OS® server, Windows® NT server), a network communication module 716, corpus of queries 718, query graph 720, query map 722, and search engine 724. The operating system 714 can be multi-user, multiprocessing, multitasking, multithreading, real time, etc. The operating system 714 performs basic tasks, including but not limited to: recognizing input from and providing output to the devices 706, 708; keeping track and managing files and directories on computer-readable mediums 712 (e.g., memory or a storage device); controlling peripheral devices; and managing traffic on the one or more communication channels 710. The network communications module 716 includes various components for establishing and maintaining network connections (e.g., software for implementing communication protocols, such as TCP/IP, HTTP, etc.). The corpus of queries 718 can be a collection of user submitted queries, which can be a basis for generating one or more query graphs 720. Each of the query graphs 720 can contain nodes that represent queries, mass value of the nodes, and weight value of the nodes in references to documents. Query map 722 can contain parent-child pairs that can be a basis for generating child queries for a broad user query. Electronic documents 724 can includes various documents, some of which being associated with query graphs.

The architecture 700 is one example of a suitable architecture for hosting a browser application having audio controls. Other architectures are possible, which include more or fewer components. The architecture 700 can be included in any device capable of hosting an application development program. The architecture 700 can be implemented in a parallel processing or peer-to-peer infrastructure or on a single device having one or more processors. Software can include multiple software components or can be a single body of code.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network. The relationship of client and server arises by virtue of computer programs running on the respective computers and having a client-server relationship to each other.

A number of implementations of the invention have been described. Nevertheless, it will be understood that various modifications can be made without departing from the spirit and scope of the invention. Accordingly, other implementations are within the scope of the following claims.

What is claimed is:

1. A computer-implemented method, the method comprising:
receiving a current user query;
building a query graph for an electronic document based on user-submitted queries, each query comprising one or more query terms, wherein the query graph comprises queries in parent-child relationships, wherein each child query in the query graph represents a refinement of a respective parent query in the query graph;
for each of one or more of the queries in the query graph:
determining a respective mass of the query using a count of submissions of the query and a count of submissions of query refinements represented by each child of the query in the query graph;
determining a respective match score of the query based on a correlation between the query and a portion of the electronic document; and
computing a respective weight of the query in reference to the electronic document based on the mass and the match score of the query;
selecting one or more parent-child relationships in the query graph based on the mass or the computed weight of a corresponding query in the query graph and a threshold value;
generating a query map based on the selected parent-child relationships;
identifying one or more child queries that have a corresponding parent query that matches the current user query;
submitting the identified one or more child queries to a search engine; and
providing for display a merged result set that includes search results of each of the submitted child queries.

2. The method of claim 1, further comprising:
identifying a plurality of queries in the query graph that contain identical query terms, each of the plurality of queries being a child query of a distinct parent query;
representing the plurality of queries as a single query; and
substituting the identified child query of each distinct parent query in the query graph with the single query.

3. The method of claim 1, wherein determining the match score comprises applying a formula as follows:
Sm(Q,D)=(Ct/Lq+Ct/Ld)/2,
where Sm(Q, D) is the match score that measures the correlation between the query Q and the portion of the electronic document D, Ct is a number of terms that appear in both Q and D, Lq is a length of Q measured by a total number of terms in Q, and Ld is a length of the portion of the electronic document D.

4. The method of claim 3, wherein computing the weight W(Q, D) of the query Q in reference to the portion of the electronic document D comprises multiplying the match score Sm(Q, D) of the query Q by the mass of the query Q.

5. The method of claim 1, wherein computing the weight of the query in reference to the document further comprises:
multiplying a query count of the query by the match score of the query to produce the weight of the query, the query count comprising a number of times that the query has been submitted; and
for each descendent query of the query in the query graph:
multiplying a query count of the descendent query and a match score of the descendent query to produce a descendent query weight; and
adding the descendent query weight to the weight of the query.

6. The method of claim 1, wherein each submission of the query or query refinement that is counted is the submission of the query or query refinement to a search engine causing retrieval of one or more electronic documents.

7. The method of claim 1, further comprising:
adjusting a ranking of the electronic document as a search result for one of the submitted child queries based on the computed weight of the corresponding query in the query graph.

8. A computer program product stored on a non-transitory computer storage medium, operable to cause data processing apparatus to perform operations comprising:
receiving a current user query;
building a query graph for an electronic document based on user-submitted queries, each query comprising one or more query terms, wherein the query graph comprises queries in parent-child relationships, wherein each child query in the query graph represents a refinement of a respective parent query in the query graph;
for each of one or more of the queries in the query graph:
determining a respective mass of the query using a count of submissions of the query and a count of submissions of query refinements represented by each child of the query in the query graph;
determining a respective match score of the query based on a correlation between the query and a portion of the electronic document; and
computing a respective weight of the query in reference to the electronic document based on the mass and the match score of the query;
selecting one or more parent-child relationships in the query graph based on the mass or the computed weight of a corresponding query in the query graph and a threshold value;
generating a query map based on the selected parent-child relationships;
identifying one or more child queries that have a corresponding parent query that matches the current user query;
submitting the identified one or more child queries to a search engine; and
providing for display a merged result set that includes search results of each of the submitted child queries.

9. The computer program product of claim 8, wherein the operations further comprise:
identifying a plurality of queries in the query graph that contain identical query terms, each of the plurality of queries being a child query of a distinct parent query;
representing the plurality of queries as a single query; and
substituting the identified child query of each distinct parent query with the single query.

10. The computer program product of claim 8, wherein determining the match score comprises applying a formula as follows:
Sm(Q,D)=(Ct/Lq+Ct/Ld)/2,
wherein Sm(Q, D) is the match score that measures the correlation between the query Q and the portion of the electronic document D, Ct is a number of terms that appear in both Q and D, Lq is a length of Q measured by a total number of terms in Q, and Ld is a length of the portion of the electronic document D.

11. The computer program product of claim 10, wherein computing the weight W(Q, D) of the query Q in reference to the portion of the electronic document D comprises multiplying the match score Sm(Q, D) of the query Q by the mass of the query Q.

12. The computer program product of claim 8, wherein computing the weight of the query in reference to the document further comprises:
multiplying a query count of the query by the match score of the query to produce the weight of the query, the query count comprising a number of times that the query has been submitted; and
for each descendent query of the query in the query graph:
multiplying a query count of the descendent query and a match score of the descendent query to produce a descendent query weight; and
adding the descendent query weight to the weight of the query.

13. The computer program product of claim 8, wherein each submission of the query or query refinement that is counted is the submission of the query or query refinement to a search engine causing retrieval of one or more electronic documents.

14. The computer program product of claim 8, wherein the operations further comprise:
adjusting a ranking of the electronic document as a search result for one of the submitted child queries based on the computed weight of the corresponding query in the query graph.

15. The computer program product of claim 8, wherein adjusting the ranking of the electronic document further comprises:
filtering the query graph by excluding from the query graph queries whose weights do not exceed a threshold; and
increasing or decreasing the ranking of the electronic document according to the computed weight of the corresponding query in the filtered query graph.

16. The computer program product of claim 8, wherein filtering the query graph comprises:
calculating a score S(Q2, D) for each query Q2 in the query graph in reference to the portion of the electronic document D using a formula:
S(Q2,D)=W(Q2,D)/M(Q2)−k/N(Q2),
wherein
W(Q2, D) is a weight of the query Q2 in reference to the portion of the electronic document D;
M(Q2) is a mass of the query Q2;
k is the threshold; and
N(Q2) is a number of child queries of the query Q2; and
excluding from the query graph queries whose scores are less than or equal to 0.

17. A system comprising:
one or more computers configured to perform operations comprising:
receiving a current user query;
building a query graph for an electronic document based on user-submitted queries, each query comprising one or more query terms, wherein the query graph comprises queries in parent-child relationships, wherein each child query in the query graph represents a refinement of a respective parent query in the query graph;
for each of one or more of the queries in the query graph:
determining a respective mass of the query using a count of submissions of the query and a count of submissions of query refinements represented by each child of the query in the query graph;
determining a respective match score of the query based on a correlation between the query and a portion of the electronic document; and
computing a respective weight of the query in reference to the electronic document based on the mass and the match score of the query;
selecting one or more parent-child relationships in the query graph based on the mass or the computed weight of a corresponding query in the query graph and a threshold value;
generating a query map based on the selected parent-child relationships;
identifying one or more child queries that have a corresponding parent query that matches the current user query;
submitting the identified one or more child queries to a search engine; and
providing for display a merged result set that includes search results of each of the submitted child queries.

18. The system of claim 17, wherein the operations further comprise:
identifying a plurality of queries in the query graph that contain identical query terms, each of the plurality of queries being a child query of a distinct parent query;
representing the plurality of queries as a single query; and
substituting the identified child query of each distinct parent query in the query graph with the single query.

19. The system of claim 17, wherein determining the match score comprises applying a formula as follows:
Sm(Q,D)=(Ct/Lq+Ct/Ld)/2,
wherein Sm(Q, D) is the match score that measures the correlation between the query Q and the portion of the electronic document D, Ct is a number of terms that appear in both Q and D, Lq is a length of Q measured by a total number of terms in Q, and Ld is a length of the portion of the electronic document D.

20. The system of claim 19, wherein computing the weight W(Q, D) of the query Q in reference to the portion of the electronic document D comprises multiplying the match score Sm(Q, D) of the query Q by the mass of the query Q.

21. The system of claim 17, wherein computing the weight of the query in reference to the document further comprises:
multiplying a query count of the query by the match score of the query to produce the weight of the query, the query count comprising a number of times that the query has been submitted; and
for each descendent query of the query in the query graph:
multiplying a query count of the descendent query and a match score of the descendent query to produce a descendent query weight; and
adding the descendent query weight to the weight of the query.

22. The system of claim 17, wherein each submission of the query or query refinement that is counted is the submission of the query or query refinement to a search engine causing retrieval of one or more electronic documents.

23. The system of claim 17, wherein the operations further comprise:
adjusting a ranking of the electronic document as a search result for one of the submitted child queries based on the computed weight of the corresponding query in the query graph.
